(19) United States
(12) Patent Application Publication
(10) Pub. No.: US 2025/0350683 A1
(43) Pub. Date: Nov. 13, 2025

(54) GENERATIVE ARTIFICIAL INTELLIGENCE-POWERED CALL INSIGHTS AND RESPONSE RECOMMENDATION SYSTEM

(71) Applicant: NICE LTD., Ra'anana (IL)

(72) Inventors: Yonatan ROSEN, RA'ANANA (IL); Roni NAKASH, Jerusalem (IL); Or GERSHON, Petah Tikva (IL); Gennadi LEMBERSKY, Haifa (IL); Eliya SHTRASER, Talmon (IL); Din EZRA, Beer sheva (IL)

(21) Appl. No.: 18/659,752

(22) Filed: May 9, 2024

(51) Int. Cl. H04M 3/42

(52) U.S. Cl. CPC H04M 3/42221; H04M 3/42025; H04M 2201/40; H04M 2201/60

(57) ABSTRACT

An artificial intelligence (AI)-based call response system and methods are provided that are configured to provide a context-based recommendation during a monitored conversation. The AI-based call response system includes a processor to perform conversation analysis operations, including determining transcribed words for the monitored conversation, analyzing the words using one or more machine learning (ML) models to produce a score associated with a model identifier (ID) identifying a ML model, comparing the score to a predefined threshold of the ML model, generating an alert when the score meets or exceeds the threshold, the alert including the model ID and a call identifier (ID) identifying the monitored conversation, creating one or more prompts with each prompt comprising an executable instruction that prompts, queries, or requests an output from a large language model for a response, retrieving the response for each of the prompts, and providing the response to a user.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to artificial intelligence (AI) and machine learning (ML) systems and models, such as those that may be used for monitoring calls to provide recommendations, and more specifically to a system and method for providing context-based responses in customer-agent interactions using an AI-based call response system during a monitored conversation.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized (or be conventional or well-known) in the prior art. The subject matter in the background section merely represents different approaches, which in and of themselves may also be inventions.

Call centers are designed to handle calls or chats to provide customer service on behalf of a company. These customer centers typically employ agents or representatives who have been trained to provide customer service or technical support. Even with sufficient training, an agent may need help during a conversation, e.g., during a voice call or during a live chat on a website or an application. If the conversation turns into a problematic session, e.g., if there is a verbal confrontation with extreme behaviors, the agent may need help, particularly to navigate such difficult situations with empathy and professionalism. Even during a normal customer service session, the agent may simply need additional information, detailed knowledge, or expertise beyond the agent's own knowledge base or experience. Therefore, there is a need to help agents or representatives in real time so that they may provide better customer service or technical support during contentious support sessions with customers.

Several software-based solutions are currently available to enhance customer-agent interactions. These currently available solutions are limited, however, in that they provide generic interactive recommendations, i.e., they are not easily adaptable to the context of the interaction between the customer and the agent, particularly with respect to problematic behaviors that may be encountered during the conversations. Thus, there is a need for a more robust and comprehensive call response system to provide context-based responses and recommendations in real time that can greatly empower agents or representatives to provide better customer service during monitored conversations.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 depicts a block diagram illustrating an artificial intelligence (AI)-based call response system for providing a context-based response during a monitored conversation, in accordance with various embodiments.

FIG. 2 depicts a block diagram of computing modules of an AI-based call response system for providing a context-based response during a monitored conversation, in accordance with various embodiments.

FIG. 3 depicts a block diagram of example automatic speech recognition engine components, in accordance with various embodiments.

FIG. 4 depicts a process flow of an example real-time model algorithm, in accordance with various embodiments.

FIG. 5 depicts a process flow of an example alert manager algorithm, in accordance with various embodiments.

FIG. 6 depicts a block diagram of another computing module of an AI-based call response system for providing a context-based response during a monitored conversation, in accordance with various embodiments.

FIG. 7 depicts a process flow of an example insights and recommendations module, in accordance with various embodiments.

FIG. 8 depicts a conceptual flow for automated actions, in accordance with various embodiments.

FIG. 9A illustrates a user interface of an AI-based call response system, in accordance with various embodiments.

FIG. 9B depicts an alert panel displaying the results of the insights and the recommendation prompts as part of a response to a conversation, in accordance with various embodiments.

FIG. 10 is a block diagram of a computer system for an AI-based call response system, in accordance with various embodiments.

FIG. 11 is a flow chart for a method for providing a context-based recommendation during a monitored conversation, in accordance with various embodiments.

FIG. 12 is a flow chart for another method for providing a context-based recommendation during a monitored conversation, in accordance with various embodiments.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

In accordance with various embodiments disclosed herein, an artificial intelligence (AI)-based call response system is described in detail. The disclosed call response system is configured to provide a context-based response or recommendation during a monitored conversation, e.g., between an agent and a customer. The conversation may take place during a phone call or a video call, or in a chat window where the conversation occurs via text.

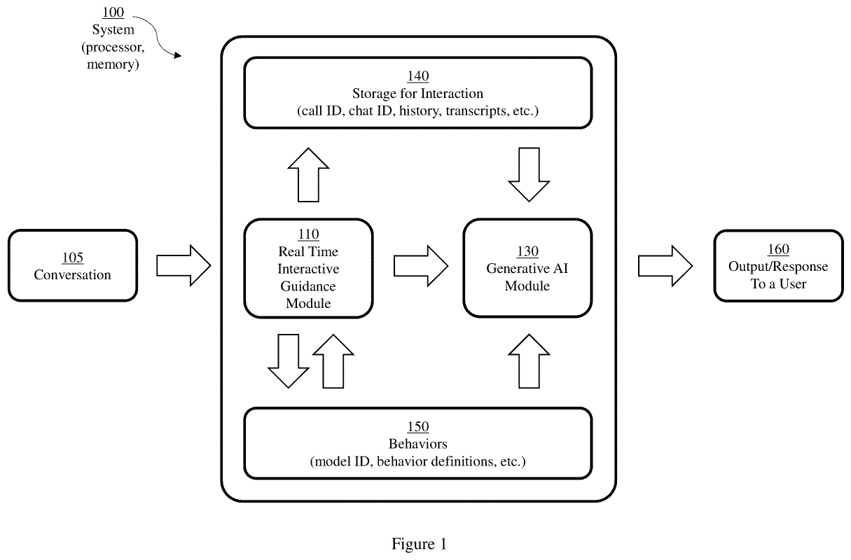

FIG. 1 depicts a block diagram illustrating an artificial intelligence (AI)-based call response system 100 for providing a context-based response during a monitored conversation 105, in accordance with various embodiments. As illustrated in FIG. 1, the call response system 100 may include a computer system having one or more processors and a non-transitory computer readable medium, e.g., a memory, operably coupled to the processor(s). The computer system/processor may be configured to execute instructions stored on the memory/non-transitory computer readable medium. The instructions may include a set of instructions to perform various conversation analysis operations during the conversation 105 or after the conversation. These operations may include, but not limited to, transcribing a voice call to words via a real-time interactive guidance (RTIG) module 110, determining transcribed words for a monitored conversation and storing the transcribed words of the interaction in storage 140. The instructions also include analyzing the transcribed words using one or more machine learning models stored in behaviors 150. The analysis produces a score associated with a model identifier (ID) identifying a machine learning model of the one or more machine learning models from the behaviors 150. In one or more embodiments, the behaviors 150 may be configured to store model IDs, behavior definitions, etc. In some embodiments, analyzing of the transcribed words may include comparing the score to a predefined threshold of a specific machine learning model, and generating an alert when the score meets or exceeds the predefined threshold of the model. In one or more embodiments, the alert may include the model ID and a call identifier (ID) identifying the monitored conversation 105, and subsequently create one or more prompts based on the alert. In some embodiments, each of the prompts may include an executable instruction that in turn prompts, queries, or requests an output from a generative artificial intelligence (GenAI) module 130, such as a large language model (LLM), for a response. Furthermore, the AI-based call response system 100 may retrieve the response for each of the one or more prompts and provide or output the response 160 to a user. The response 160 may be in a single response format or multiple responses combined into a single response format. The user that receives response 160 may be an agent, a supervisor of the agent, a third party, or the customer if the conversation occurs in a chat window, or a combination of the foregoing, in accordance with some embodiments.

As described herein, the disclosed (AI)-based call response system 100 may possess real-time interactive guidance capabilities that can provide more value and can have a more significant impact on call center interactions and the overall customer experience. The capabilities of the disclosed call response system include identifying and addressing behavioral issues in real time, which may improve the effectiveness, performance, and efficiency of agents/representatives, which in turn may lead to enhanced customer satisfaction and loyalty. In addition, the call response system may provide solutions that empower agents/representatives with valuable insights and recommendations that may enable them to navigate difficult situations with empathy and professionalism. This effective AI-powered response system can result in reduced customer frustration, increased resolution rates, and improved agent performance. Moreover, the call response system can also assist supervisors of the agents/representatives by providing context alerts during the agent-customer conversations. The system may also generate insights that provide a direct, focused, real-time alert that can help reduce supervision response time. The impact of the disclosed call response system's solutions can advantageously translate into stronger customer relationships, positive brand reputation, and potential business growth.

As disclosed herein, the AI-based call response system 100 centers on the integration of the RTIG module 110 with the GenAI module 130, which may employ a large language model (LLM), to analyze and provide feedback on customer-agent interactions, such as the conversation 105. The combination of RTIG module 110 and GenAI module 130, for example, may be cost effective, as the integrated components may significantly lower the demand on the GenAI services, thereby, for example, reducing the access request for GenAI services such that the LLM may be limited to cases when an alert is triggered. In some embodiments, the call response system 100 may create an automatic corrective action, which may be triggered as part of the recommendation part of LLM output of the Gen-AI service by the GenAI module 130. The call response system 100 may also be configured to automatically send the corrective action to the customer for chat-based monitored conversations, in some embodiments. In one or more embodiments, the call response system 100 may automatically create a coaching session by sending a summary, insights and recommendations to an external application configured for coaching a new agent or representative. Such external applications, e.g., coaching applications, may help facilitate one or more coaching sessions by focusing on the problematic behaviors and preparing them as case studies or lessons for new agents or representatives to learn as part of their training.

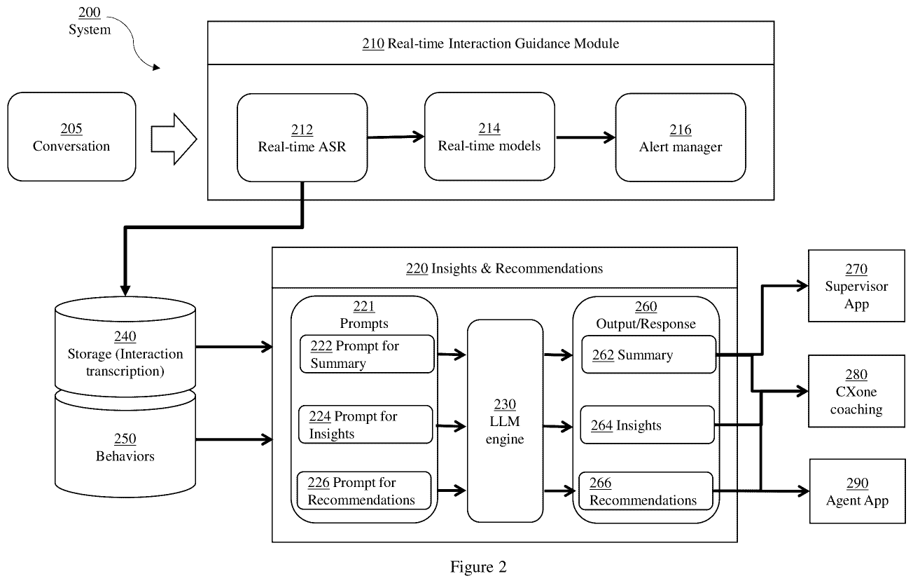

As described in FIG. 1 above, interactive conversations, such as conversation 105 can be monitored by the RTIG module 110 to collect the transcript of the conversations, e.g., via calls or chats. When an alert is triggered, the transcript together with the definition of problematic behaviors can be sent to the GenAI module 130 that can provide a short summary, an explanation, or an insight about the conversation with respect to a problematic behavior (e.g., what was wrong, how to avoid the behavior in the future, how to minimize the consequences, etc.), and a recommendation to fix such problematic behavior, all in the form of an output response 160, in accordance with some embodiments. The detailed operations of the AI-based call response system 100 are further described with respect to FIG. 2.

FIG. 2 depicts a block diagram of various computing modules of an AI-based call response system 200 for providing a context-based response during a monitored conversation, in accordance with various embodiments. As depicted in FIG. 2, the AI-based call response system 200 includes a real-time interactive guidance (RTIG) module 210 for transcribing conversation 205 in real time via a real-time automatic speech recognition (RTASR) module 212. The RTIG module 210 is responsible for real-time transcription and analysis of ongoing interactions.

As part of a first step (e.g., Step 1), conversation 205 is monitored by the RTIG module 210 where the interaction is automatically transcribed in real time via the RTASR module 212. In one or more embodiments, every time a new word is transcribed, the transcription collected so far, is sent to real-time models 214 within the RTIG module 210 and a score is generated and sent to an alert manager 216, also within the RTIG module 210. If and when one or more of the scores crosses a predefined threshold, the alert is generated by the alert manager 216. All of such interactions, including the transcription, e.g., transcribed words, are stored in a storage (for interaction transcription) 240, which is similar to storage 140 as described with respect to FIG. 1.

As depicted in FIG. 2, the AI-based call response system 200 also includes an insights & recommendations (IR) module 220. As part of a second step (e.g., Step 2), the IR module 220 is configured to listen to the alert manager 216 of the RTIG module 210. If there is an alert related to a specific behavior, the IR module 220 collects the interaction transcription collected so far and the definition of the alerting behavior, respectively from storage 240 and behaviors 250. As further depicted in FIG. 2, the IR module 220 then creates several prompts 221 for retrieving at least the following information-a short summary of the interaction via prompt 222; what was wrong in the interaction with respect to the problematic behavior (i.e., insights) via prompt 224; and what the agent should say (or type) to improve the situation (i.e., recommendations) via prompt 226, among many others. Once the prompts 221 that query from a GenAI module, such as LLM engine 230, LLM engine 230 can generate an output/response 260 that includes summary 262, insights 264, and recommendations 266, in the form of a single output response or multiple responses. Each of the responses may then be provided or presented externally, for example, to supervisor app 270, CXone coaching 280, or agent app 290, as appropriate, as depicted in FIG. 2.

In one or more embodiments, storage 240 may include any storage component of the following: search engine (e.g., Elastic Search or Apache Lucene), relational database (e.g. MySQL, MS SQL Server) or any other storage capable of storing and quickly retrieving textual information. In accordance with one or more embodiments, storage 240 can be configured to store interaction transcriptions word-by-word in real time and retrieve it in relevant part or in its entirety in case of an alert. In one or more embodiments, storage 240 may be configured to store behavior definitions or another associated storage can be configured to do so. The stored behavior definitions include definitions of monitored behaviors (such as the example below) and can be retrieved for LLM wrapper components, such as prompts 221, for example, for sending to the LLM engine 230 for processing.

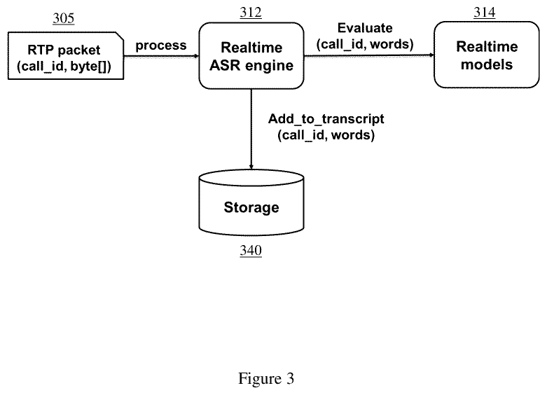

FIG. 3 depicts a block diagram of example automatic speech recognition engine components, in accordance with various embodiments. As conversations, such as conversations 105 or 205, can be phone conversations that are transcribed in real time via an automatic speech recognition module RTASR 312 as depicted in FIG. 3. During this process, the conversation is converted into real-time transport protocol (RTP) packets 305 with audio information and designated as call_ID. In one or more embodiments, the phone conversation is transmitted as RTP packets 305 to the RTASR 312 that analyzes it and transcribes the audio information in the packets to text (array of words). The transcribed text together with the relevant call_ID is sent to storage 340 that appends it to already transcribed portion of the call. The RTASR 312 also sends the transcribed text to the real-time models 314.

In accordance with various embodiments, the real-time models 314 may include a set of text classification models each of which evaluates a specific aspect of a given text. For example, the sentiment model assesses the ‘sentiment’ of the text and returns a high number if the sentiment is positive and a low number if the sentiment is negative. Other models can refer to any specific agent or customer behaviors, e.g. ‘show appreciation’ or ‘make it effortless’. The ‘real-time models 314 evaluate the text continuously, so that every new portion of the transcribed conversation is evaluated and the models scores are updated. As such, the algorithm can be described as follows: Input: call_ID, transcribed text (a new portion of the conversation), Output: model_ID, score pairs—each model outputs a score that corresponds to a specific behavior/aspect of from a beginning of a conversation to the current point of time.

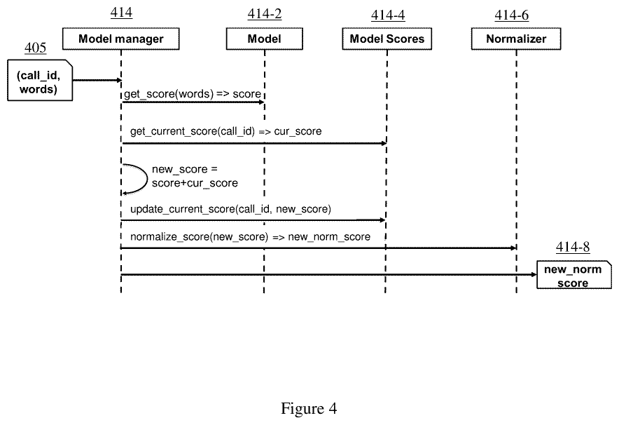

FIG. 4 depicts a process flow of an example real-time model algorithm, in accordance with various embodiments. As depicted in FIG. 4, the process flow begins when transcribed words 405 with a call_ID is input to model manager 414. The model manager 414 contains several stateless real-time models 414-2. It keeps track of current model scores 414-4 for all models 414-2 and calls in the model score table, such as Table 2 below, and implements the logic described in this algorithm. In one or more embodiments, real-time models 414-2 can be viewed as a table that maps a word or a phrase into a float number (weight) that corresponds to the power of association between the phrase and the specific behavior measured by the model. For example, the phrase: “listen to me” can have a strong negative weight while the phrase “thanks for your help” can usually have a positive weight as shown in Error! Reference source not found. below.

TABLE 1

| Phrase | Weight |
|---|---|
| listen to me | −0.94 |
| thanks for your help | 3.34 |

Table 2 below shows model scores for each model and the ongoing call keeps its latest score.

TABLE 2

| Model Id | Call Id | Score |
|---|---|---|
| Model1 UUID | Call1 UUID | 0.34 |
| Model1 UUID | Call2 UUID | −0.24 |
| Model2 UUID | Call1 UUID | 2.25 |
| Model2 UUID | Call2 UUID | −1.55 |
| Model3 UUID | Call1 UUID | 2.43 |
| Model3 UUID | Call2 UUID | −1.80 |

FIG. 4 further shows a normalizer 414-6 for normalizing the scores. The normalizer 414-6 transforms the score to the 0 to 1 range for easier interpretation. The normalizer can be model-specific or generic. There are many transformation methods that can be used, for example the sigmoid function S (x):

$$S ( x ) = \frac{1}{1 + {e}^{x}}$$

where x is the raw model score. The algorithm works as follows: the model manager 414 receives the new portion of a transcribed call, which may include a call_ID and a few words. For each model, the model manager 414:
1) Sends the received words to the model and gets the score.
2) Retrieves the current score for this call from the model scores table.
3) Calculates the new score (e.g. by summing the current score with the score received from the model).
4) Updates the model scores table with the new score.
5) Normalizes the new score and passes it to the alert manager.

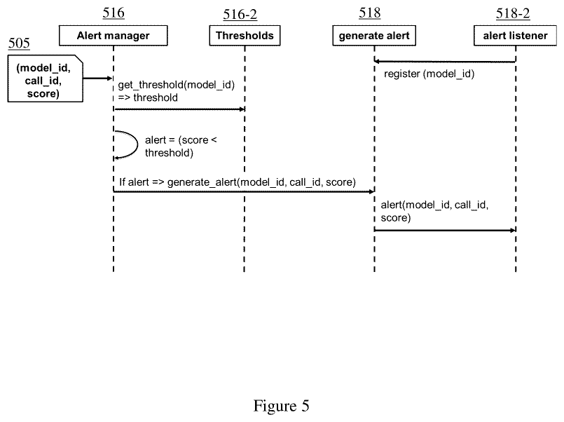

FIG. 5 depicts a process flow of an example alert manager algorithm, in accordance with various embodiments. As depicted in FIG. 5, alert manager 516 compares the latest score of transcribed words 505 with a model_ID, a call_ID, and/or score received from a specific real-time model to a predefined threshold at thresholds 516-2 and triggers an alert at generate alert 518 in case the score is below (or above) the threshold. Additionally, the alert manager 518 contains a list of registered alert listeners 518-2, each of which can register to receive alerts related to specific models. When an alert is generated, the alert object is passed to every listener registered to receive alerts related to this model. In this instance, the input is call_id, list of model_ID, and scores pairs for all models and the output is an alert for each score below a threshold, as depicted in FIG. 5.

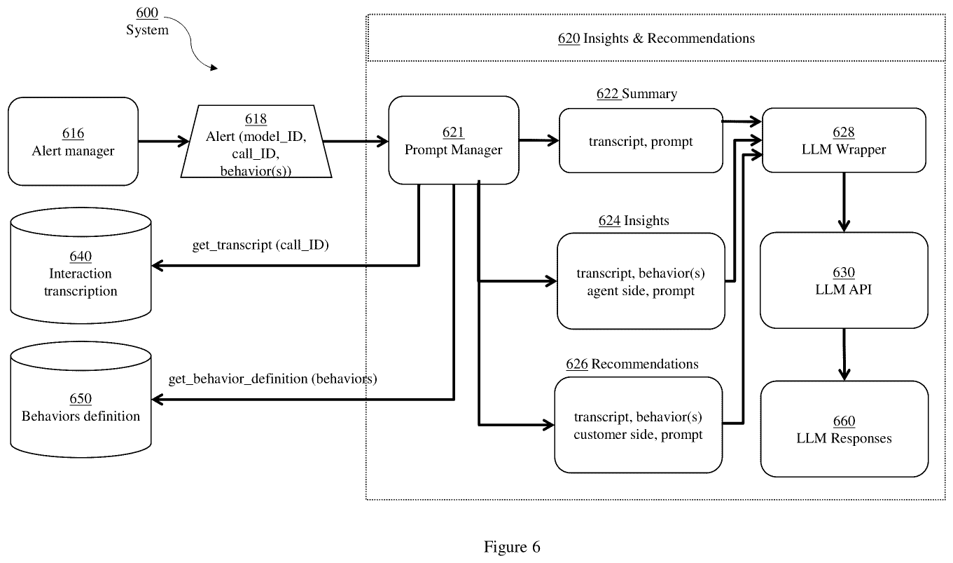

FIG. 6 depicts a block diagram of another computing module of an AI-based call response system 600 for providing a context-based response during a monitored conversation, in accordance with various embodiments. As depicted in FIG. 6, the AI-based call response system 600 includes insights & recommendations (IR) module 620. The IR module 620 includes a prompt manager module 621 that ‘listens’ to alert manager 616, so it is notified if an alert 618 has been triggered. The alert 618 may include model_ID, call_ID and behavior(s). As depicted in FIG. 6, prompt manager 621 uses the model ID from alert 618 to extract the description of the relevant model from the storage. It also uses the call_ID from alert 618 to extract the transcript of the relevant interaction collected up to this point. The prompt manager 621 uses the transcription and the model description to create three instructional prompts to summarize the call via prompt summary 622, to explain the alert via prompt insights 624 and to recommend the corrective action via prompt recommendations 626. Each of the prompts 622, 624, and 626 is sent to a generative AI module (a large language model (LLM), such as for example, but not limited to gpt-4 or Mistral), which is indicated as a LLM API 630 via LLM wrapper 628 that handles LLM configuration, as depicted in FIG. 6. Once requested, LLM API 630 then provides response 660 for each of the prompts 622, 624, and 626. Response 660 may include a single response or multiple responses.

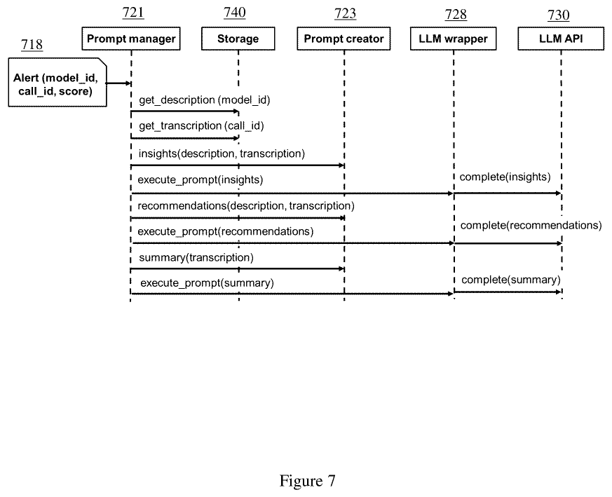

FIG. 7 depicts a process flow of an example insights and recommendations module, in accordance with various embodiments. As depicted in FIG. 7, when alert 718 is generated, prompt manager 721 reads model_ID, call_ID, and score based on alert 718 and retrieve description of model_ID and transcription of call_ID from storage 740, send requests for a prompt for summary, a prompt for insights, and a prompt for recommendations to prompt creator 723 and then to LLM wrapper 728, which then send the prompts to LLM API 730 to execute the requests and to generate responses for each of the prompts.

In general, the prompting manager 721 described in FIG. 7 may include three components, including a specific instruction to the LLM, a conversation transcription until the moment of an alert, and definitions of the desired behaviors an agent should demonstrate during an interaction. A behavior may be assessed by a dedicated real-time model, as described above. The behavior can focus on the agent or the customer's perspective. See below the partial list of behaviors currently supported by our systems. Table 3 below shows some example agent-side behavior definitions. Table 4 below shows some example customer side behavior definitions.

TABLE 3

| Behavior | Side | Definition |
|---|---|---|
| Warm and | Agent | Create a personal connection so that customers |
| Friendly | | feel valued and well cared for |
| Own It | Agent | Do everything possible to resolve the issue, |
| | | instilling confidence and trust with the customer. |
| Show | Agent | Recognize the customer's existing or intended |
| Appreciation | | relationship with the company and/or |
| | | acknowledge the significance of customer's |
| | | loyalty |
| Make it | Agent | Make all interactions for the customer quick and |
| Effortless | | easy, promote digital or self-service capabilities |
| | | for future use |
| Listen | Agent | Customize the conversation by listening for cues |
| Actively | | and tailor response to the customer's experience |
| Discover | Agent | Ask thoughtful, relevant questions, collaborating |
| Needs | | with the customer to thoroughly define the |
| | | opportunity or issue, and identify the best |
| | | solution |
| Set Clear | Agent | Keep customer informed throughout the |
| Expectations | | interaction using transparent communication |
| | | ensuring next steps are understood |

TABLE 4

| Behavior | Side | Definition |
|---|---|---|
| Warm and | Customer | Personally connected and can relate to the |
| Friendly | | agent. The agent is engaging, trusting, |
| | | empathic, and authentic. Valued as a customer |
| Own It | Customer | Confident they have reached an expert. The |
| | | agent has a ‘can do’ attitude with a |
| | | sincere willingness to see their issue through |
| | | to full resolution. The agent is accountable |
| | | and does not place blame on other teams. |
| Show | Customer | Recognized for being a loyal customer. Feels |
| Appreciation | | that they are important and valued. Cared for, |
| | | agent is focused on recommending the best |
| | | service offering and addressing their concern |
| | | or issue. |
| Make it | Customer | As if the agent made the interaction ‘easy’. |
| Effortless | | The agent respects the time of the customer and |
| | | wants to make sure that their needs are met |
| | | with one call. The agent demonstrates how the |
| | | products and online tools are easy to learn and |
| | | use. |
| Listen | Customer | The agent is listening and understands their |
| Actively | | concern and is acknowledging information or |
| | | updates given by customer. The agent is |
| | | actively engaged, hearing everything the |
| | | customer says the first time. The agent |
| | | provided relevant and clear information |
| Discover | Customer | The agent asked the right questions, in a |
| Needs | | conversational manner, to ensure they have the |
| | | information needed to resolve the issue. The |
| | | agent knows what matters most to them and |
| | | why. Agent is knowledgeable in uncovering |
| | | root cause and matching solutions. |
| Set Clear | Customer | Kept informed of what they are doing to |
| Expectations | | resolve the issue throughout the interaction |
| | | and avoiding self-talk. The agent clearly |
| | | disclosed actions taken, expected next steps, |
| | | any changes in fees or recurring charges, and |
| | | associated timing. Knowledgeable of the |
| | | situation and resolution. |

There are three types of prompts supported by the system: insights, recommendation, and a summary. In one or more embodiments, the insight module's goal is to deliver in-context explanation on what was erroneous in an interaction in terms of one or more agent's behaviors. The insights prompt may include:
Real-time transcription of the interaction from the beginning to the current time.
Definition of the behavior that triggered the alert (agent side).
Instruction for the LLM to explain why the agent did not demonstrate the desired behavior, and to support the explanation by extracting most indicative phrases from the interaction.

### Example

‘‘‘{transcription}’’’
A call is the text above which is delimited by triple backticks.
{behavior} is defined as {behavior_definition_agent}
Use the content of the call to explain why the agent did not demonstrate
the {behavior}

### Insights Prompt Algorithm

### Input:

Text variable, which is a string of the interaction transcript until current time stamp
List of alerted behaviors
Dictionary of agent side behaviors

### Output:

Prompt, which is a string variable

### Algorithm:

If Alert type is Sentiment”
Prompt=““{text}””. A call is the text above which is delimited by triple backticks. Explain why the sentiment in the call was negative by extracting supporting phrases from the call. Limit the explanation to 3 most indicative phrases at the most.
   Else (One or more behaviors triggered the alert)
1. prompt_1=“{text}”. A call is the text above which is delimited by triple backticks. The following behaviors have the following definitions:
2. prompt_2=Empty string
   for behavior in alerted behaviors:

$$definition = \{ behavior \} is defined as \{ Behaviors\_agent \_side [ behavior ] \}$$

$$prompt\_ 2 = concatenation ( prompt\_ 2 , definition )$$

3. prompt_3=Explain why the agent did not demonstrate the behaviors by extracting supporting phrases from the call. Limit the explanation to 2 most indicative phrases at the most:
   for behavior in alerted behaviors

$$prompt\_ 3 = concatenation ( prompt\_ 2 , \{ behavior \} )$$

4. prompt_4=Explanation:
5. prompt=concatenation (prompt_1, prompt_2, prompt_3, prompt_4)

The recommendation module goal is to provide a recommendation to the agent to relieve current situation in an interaction by recommending the agent an in-context response that would follow definitions in terms of the customer's experience. The recommendation prompt includes:
Real-time transcription of the interaction
Definition of the behavior that triggered the alert (customer side)
Request for the LLM to generate an agent response that would follow the customer side definition.

### Example

‘‘‘{transcription}’’’
A call is the text above which is delimited by triple backticks.
Generate a response of the agent such that the customer will feel:
{behavior_definition_customer}
Limit your response to 60 words.

### Recommendation Prompt Algorithm

### Input:

Text variable, which is a string of the interaction transcript until current time stamp
List of alerted behaviors
Dictionary of customer side behaviors

### Output:

Prompt, which is a string variable

### Algorithm:

If Alert type is “Sentiment”
Prompt=“{text}”. A call is the text above which is delimited by triple backticks. Generate a response of the agent that will change the sentiment of the call into a positive sentiment. Limit your response to 70 words. Agent:
   Else (One or more behaviors triggered the alert)
1. prompt_1=“{text}”. A call is the text above which is delimited by triple backticks. Generate a response of the agent such that the customer will feel:
2. prompt_2=Empty string
   for behavior in alerted behaviors:

$$definition = \{ behavior \} is defined as \{ Behaviors\_customer \_side [ behavior ] \}$$

$$prompt\_ 2 = concatenation ( prompt\_ 2 , definition )$$

3. prompt_3=Limit your response to 60 words. Agent:
4. prompt=concatenation (prompt_1, prompt_2, prompt_3)

The summary prompt creates a short summary of the interaction. The summary prompt includes:
Real-time transcription of the interaction
Request for the LLM to generate a concise summary of the interaction of limited length.

### Example

‘‘‘{transcription}’’’
A call is the text above which is delimited by triple backticks.
Provide a concise summary of the call. Do not exceed 60 words.

Data Structures

| Variable | Data Type/Structure |
|---|---|
| agent_id | UUID |
| alert | Complex structure comprising: |
| | alert_id (UUID) |
| | call_id (UUID) |
| | model_id (UUID) |
| | score (Float) |
| call_id | UUID |
| call transcription | Text |
| model_id | UUID |
| model_name | Text (user-friendly identifier of a model |
| model_description | Text (aka behavior description). A detailed |
| | description of the model's meaning from agent and |
| | customer perspectives |
| score | Float (aka model score) |
| prompt | Text (sent to LLM wrapper) |
| RTP packet | Byte[ ] - byte array |
| storage (behaviors) | Map <model_id (UUID), model description (Text)> |
| storage | Map <call_id(UUID), transcription (Text)> |
| (transcription) | |
| threshold | Float |
| thresholds table | Map <model_id (UUID), threshold(Float)> |

### Results of Experiments

The disclosed AI-based call response system described herein has been performed using a set of 20 real customer anonymized calls. The set of real-time models applied to the calls included: 7 behavioral models, the sentiment model and the escalation model. The generative AI modules include two types of LLMs: gpt-3.5-turbo and gpt-4.

| | |
|---|---|
| Total calls | 20 |
| Calls with alerts | 4 |
| Alerted models | Listen actively, sentiment, escalation |
| gpt-3.5-turbo | In most cases it provided accurate results for all |
| | prompts. However, in some cases the behavior was |
| | inconsistent. |
| gpt-4 | Good performance in all cases (100% accuracy) |

### Example

See below the results we received for one of the calls:

### Insights:

The agent did not demonstrate Listen Actively behavior because they did
not acknowledge the customer's frustration with the previous interactions
and the broken item. Supporting phrases include: “i think i she just
connected me back to the same group of people who tried to help me the
first time who was that no help at all” and “this is just been a very bad
experience.” The agent's responses did not show empathy or
understanding of the customer's situation, which is essential for active
listening.

### Recommendations

I apologize for the inconvenience you've experienced. I understand your
concern about the return label and the delay in resolving this issue. I
will personally ensure that the request is expedited, and you receive the
return label as soon as possible. Your satisfaction is our priority, and
we'll do our best to make this right for you.

### Summary

The customer is frustrated with the return process for a damaged
disability swivel chair purchased from a third-party seller. They have
been waiting for a return label to be sent to them but have not received
it. The customer is considering canceling their membership due to this
negative experience.

### Automated Actions

The LLM responses are used as follows:
The call summary and the alert explanation are used to automatically create a coaching session in the coaching application.
The call summary and the alert explanation are displayed to the supervisor in the Supervisor application.
The recommendation is sent to the customer via the Agent application.

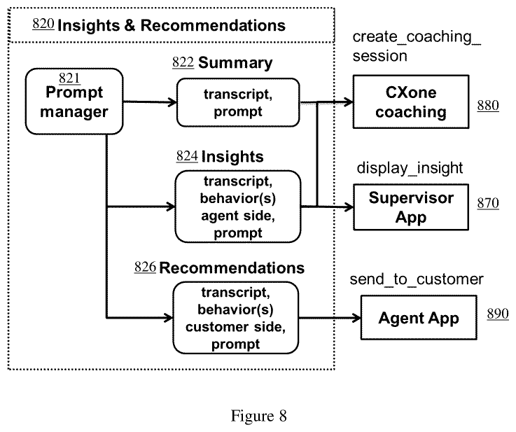

FIG. 8 depicts a conceptual flow for automated actions, in accordance with various embodiments. The flow described in FIG. 8 centers on insights & recommendations (IR) module 820, which includes prompt manager 821 that can create summary 822, insights 824, and recommendations 826 for exporting to one of supervisor application 870, coaching app 880, and/or agent app 890, as appropriate. As illustrated in FIG. 8, summary 822 and insights 824 part of the LLM output can be forwarded to supervisor application 870 and displayed to the supervisor in real time. This can be used by a supervisor to guide the agent or to actively intervene in the interaction during the monitored conversation.

### Algorithm:

1. The prompt manager gets an alert, creates three prompts and gets 3 responses as described in Error! Reference source not found.
2. The prompt manager creates a structure (e.g. in JSON format) that includes the following information:
   a. Call_ID
   b. Model_ID
   c. Score
   d. Summary response
   e. Insights response
3. The prompt manager sends this structure to the supervisor application.
4. The supervisor application displays the alert indicator to the user. If user presses on the alert the summary and the insights are displayed.

As also depicted in FIG. 8, recommendation 826 can be forwarded or sent to the agent as a suggestion on how to respond properly to the customer in order to alleviate the problematic situation. It also can be automatically sent to the customer in case of a chat conversation.

### Algorithm:

1. The prompt manager gets an alert, creates three prompts and gets 3 responses as described in Error! Reference source not found.7.
2. The prompt manager creates a structure (e.g., in JSON format) that includes the following information:
   a. Call_ID
   b. Model_ID
   c. Score
   d. Recommendations response
3. The prompt manager sends this structure to the agent application.
4. The agent application shows this response to the agent. In case of a digital conversation, the response can be sent directly to the customer.

In addition, insights 824 and summaries 822 can be forwarded or sent to coaching application 880 where a new coaching session may be automatically created focusing on the problematic behavior. A session information can be used to train an agent. First, by detection and analysis of the causes to a difficult situation using the insights. Second, by responding properly by comparing to the suggested recommendation.

### Algorithm:

1. The prompt manager gets an alert, creates three prompts and gets 3 responses as described in Error! Reference source not found.
2. The prompt manager creates a structure (e.g., in JSON format) that includes the following information:
   a. Call_ID
   b. Model_ID (model_name-user friendly identifier of the model)
   c. Agent_ID (agent handling the call)
   d. Score
   e. Summary response
   f. Insights response
3. The prompt manager sends this structure to the coaching application.
4. The coaching application automatically creates a coaching session using:
   a. Model_type as a focus area
   b. Summary and insights as problem description
   c. Call_ID as a reference interaction
5. The coaching session is assigned to agent_ID

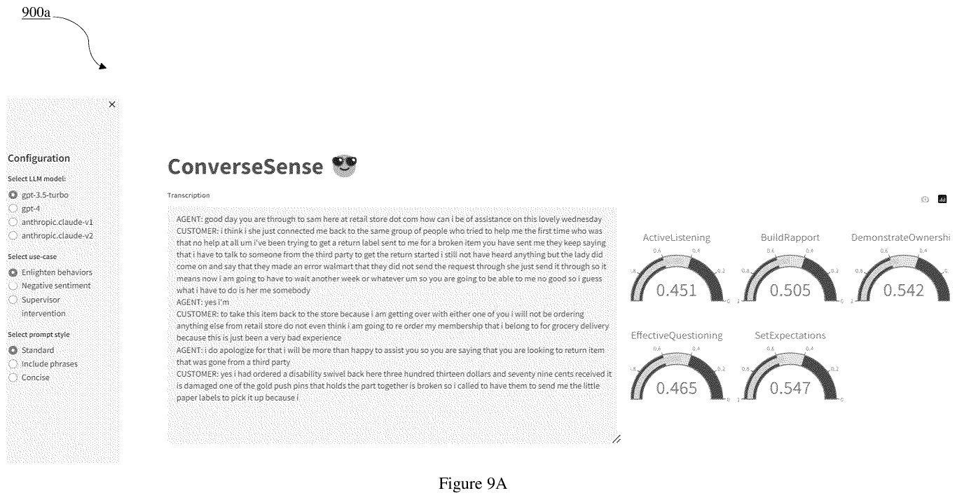

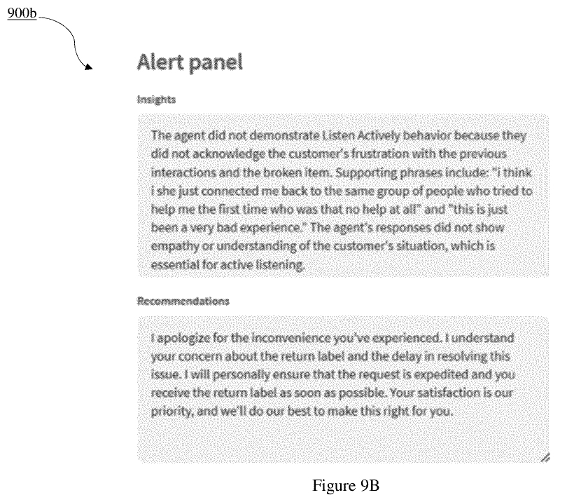

FIG. 9A illustrates a user interface 900a of an AI-based call response system, in accordance with various embodiments. The left-most panel of the user interface 900a shows some configuration options, including choosing a specific LLM model, specific scenario (one of the behaviors, negative sentiment, or the escalation scenario) and a variation of the prompt (standard, including supporting phrases and concise), as depicted in FIG. 9A. The central panel of the user interface 900a shows a real-time transcription of the voice conversation, as illustrated in FIG. 9A. The right-most panel of the user interface 900a shows the real-time score of 5 behaviors, which serve as analytical components to a conversation, in accordance with the illustrated embodiments.

FIG. 9B depicts an alert panel 900b displaying the results of the insights and the recommendation prompts as part of a response to a conversation, in accordance with various embodiments. Such insights and recommendations can be forwarded to any of the appropriate entities as described elsewhere in the application.

As depicted in FIGS. 9A and 9B, insights and summaries can be forwarded or sent to a coaching application where a new coaching session may be automatically created such that problematic behaviors can be used as training for agents/representatives. Recommendations, on the other hand, can be forwarded or sent to an agent application to suggest how to respond properly to the customer to alleviate the problematic or difficult situation, for example.

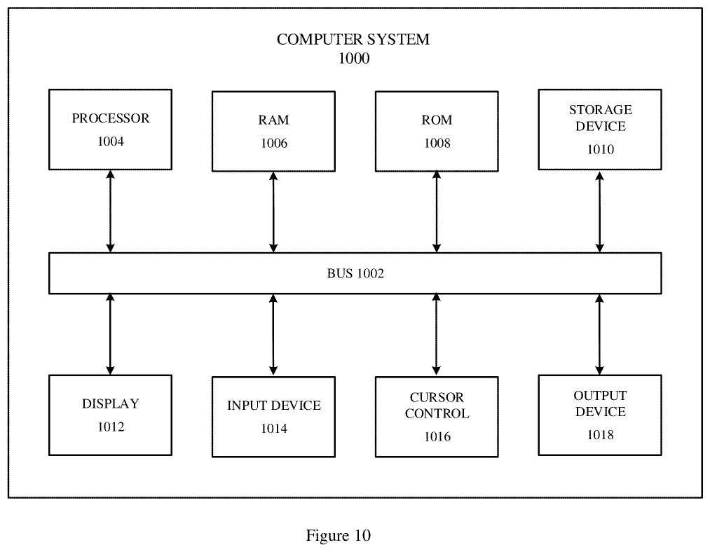

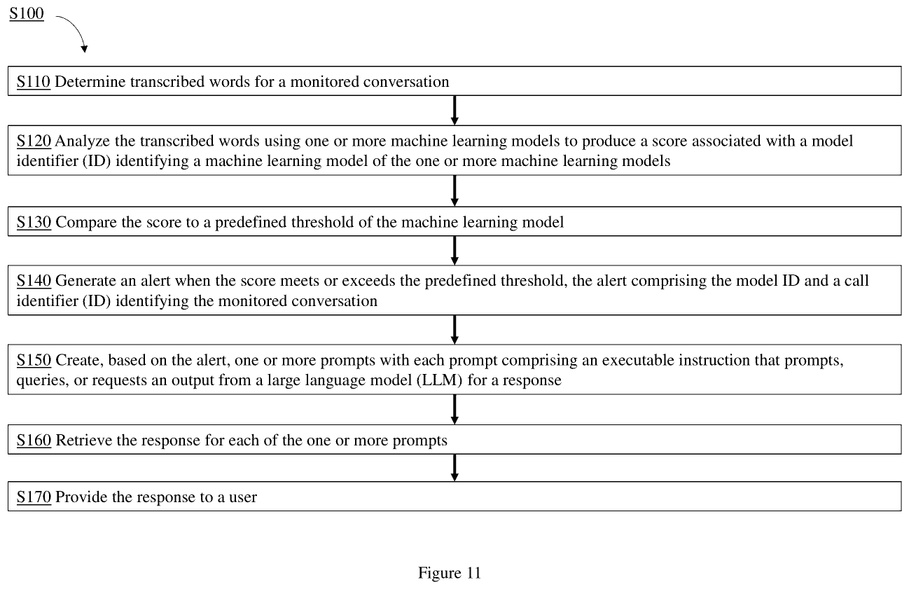

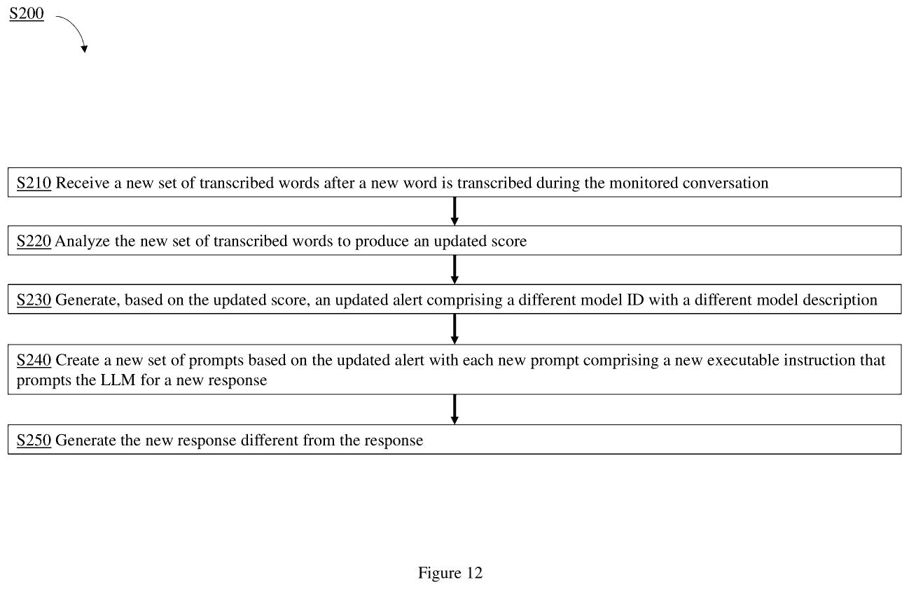

FIG. 10 is a block diagram of a computer system 1000 for an AI-based call response system, in accordance with various embodiments. The computer system 1000 may be an example of one implementation for various systems, such as various AI-based call response systems 100, 200, 600, or various processes described with respect to FIGS. 1-9, and methods, such as methods S100 and S200 as described below with respect to FIGS. 11 and 12.

In one or more examples, computer system 1000 can include a bus 1002 or other communication mechanism for communicating information, and a processor 1004 coupled with bus 1002 for processing information. In various embodiments, computer system 1000 can also include a memory, which can be a random-access memory (RAM) 1006 or other dynamic storage device, coupled to bus 1002 for determining instructions to be executed by processor 1004. Memory also can be used for storing temporary variables or other intermediate information during execution of instructions to be executed by processor 1004. In various embodiments, computer system 1000 can further include a read only memory (ROM) 1008 or other static storage device coupled to bus 1002 for storing static information and instructions for processor 1004. A storage device 1010, such as a magnetic disk or optical disk, can be provided and coupled to bus 1002 for storing information and instructions.

In various embodiments, computer system 1000 can be coupled via bus 1002 to a display 1012, such as a cathode ray tube (CRT), liquid crystal display (LCD), or light emitting diode (LED) for displaying information to a computer user. An input device 1014, including alphanumeric and other keys, can be coupled to bus 1002 for communicating information and command selections to processor 1004. Another type of user input device is a cursor control 1016, such as a mouse, a joystick, a trackball, a gesture input device, a gaze-based input device, or cursor direction keys, for communicating direction information and command selections to processor 1004 and for controlling cursor movement on display 1012. This input device 1014 typically has two degrees of freedom in two axes, a first axis (e.g., x) and a second axis (e.g., y), that allows the device to specify positions in a plane. However, it should be understood that input devices 1014 allowing for three-dimensional (e.g., x, y, and z) cursor movement are also contemplated herein.

Consistent with certain implementations of the present teachings, results can be provided by computer system 1000 in response to processor 1004 executing one or more sequences of one or more instructions contained in RAM 1006. Such instructions can be read into RAM 1006 from another computer-readable medium or computer-readable storage medium, such as storage device 1010. Execution of the sequences of instructions contained in RAM 1006 can cause processor 1004 to perform the processes described herein. Alternatively, hard-wired circuitry can be used in place of or in combination with software instructions to implement the present teachings. Thus, implementations of the present teachings are not limited to any specific combination of hardware circuitry and software.

The term “computer-readable medium” (e.g., data store, data storage, storage device, data storage device, etc.) or “computer-readable storage medium” as used herein refers to any media that participates in providing instructions to processor 1004 for execution. Such a medium can take many forms, including but not limited to, non-volatile media, volatile media, and transmission media. Examples of non-volatile media can include, but are not limited to, optical, solid state, magnetic disks, such as storage device 1010. Examples of volatile media can include, but are not limited to, dynamic memory, such as RAM 1006. Examples of transmission media can include, but are not limited to, coaxial cables, copper wire, and fiber optics, including the wires that comprise bus 1002.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, or any other tangible medium from which a computer can read.

In addition to computer readable medium, instructions or data can be provided as signals on transmission media included in a communications apparatus or system to provide sequences of one or more instructions to processor 1004 of computer system 1000 for execution. For example, a communication apparatus may include a transceiver having signals indicative of instructions and data. The instructions and data are configured to cause one or more processors to implement the functions outlined in the disclosure herein. Representative examples of data communications transmission connections can include, but are not limited to, telephone modem connections, wide area networks (WAN), local area networks (LAN), infrared data connections, NFC connections, optical communications connections, etc.

It should be appreciated that the methodologies described herein, flow charts, diagrams, and accompanying disclosure can be implemented using computer system 1000 as a standalone device or on a distributed network of shared computer processing resources such as a cloud computing network.

The methodologies described herein may be implemented by various means depending upon the application. For example, these methodologies may be implemented in hardware, firmware, software, or any combination thereof. For a hardware implementation, the processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

In various embodiments, the methods of the present teachings may be implemented as firmware and/or a software program and applications written in conventional programming languages such as C, C++, Python, etc. If implemented as firmware and/or software, the embodiments described herein can be implemented on a non-transitory computer-readable medium in which a program is stored for causing a computer to perform the methods described above. It should be understood that the various engines described herein can be provided on a computer system, such as computer system 1000, whereby processor 1004 would execute the analyses and determinations provided by these engines, subject to instructions provided by any one of, or a combination of, the memory components RAM 1006, ROM, 1008, or storage device 1010 and user input provided via input device 1014.

FIG. 11 is a flow chart for method S100 for providing a context-based recommendation during a monitored conversation, in accordance with various embodiments. As illustrated in FIG. 11, the method S100 includes, at step S110, determining, for example, but not limited to, via an automatic speech recognition system, transcribed words for the monitored conversation; at step S120, analyzing the transcribed words using one or more machine learning models to produce a score associated with a model identifier (ID) identifying a machine learning model of the one or more machine learning models; at step S130, comparing the score to a predefined threshold of the machine learning model; at step S140, generating an alert when the score meets or exceeds the predefined threshold, the alert comprising the model ID and a call identifier (ID) identifying the monitored conversation; at step S150, creating, based on the alert, one or more prompts with each prompt comprising an executable instruction that prompts, queries, or requests an output from a large language model (LLM) for a response; at step S160, retrieving the response for each of the one or more prompts; and at step S170, providing the response to a user.

In accordance with one or more embodiments described herein, the method S100 can be implemented via an artificial intelligence (AI)-based call response system, such as systems 100, 200, or 600 as described with respect to FIGS. 1-9, to provide a context-based recommendation during a monitored conversation. Furthermore, the method S100 can be implemented via any of the disclosed embodiments herein, including various process flows described with respect to any of FIGS. 1-9. Such response systems can include one or more processors and a non-transitory computer readable medium operably coupled thereto, where the non-transitory computer readable medium includes a plurality of instructions, and when executed by the one or more processors of such systems, the systems perform conversation analysis operations that encompass the method S100 with various steps described with respect to FIG. 11. In one or more embodiments, the conversation analysis operations may optionally include registering the transcribed words with the call ID and storing the transcribed words registered with the call ID in a storage, such as the various storages described with respect to the figures above.

In one or more embodiments, creating the one or more prompts at step S150 may further include, optionally, retrieving, from the storage, a model description of the model ID associated with the alert, the stored transcribed words corresponding to the call ID associated with the alert, or a combination thereof; and generating the executable instruction based on the model description, the transcribed words, or the combination thereof.

In one or more embodiments, the response provided to the user may include a summary of an interaction between a customer and an agent during the monitored conversation, an insight of the monitored conversation that includes an in-context explanation of the interaction capturing a behavior of the agent, or a recommendation that includes one or more in-context responses that follow definitions based on an experience of the customer during the monitored conversation. In one or more embodiments, even if there are multiple alerts, they can be aggregated into only a single prompt and a single response, in order to lower cost and provide real time interaction by a generative AI service/module, such as a large language model, such as any of the gpt programs. In one or more embodiments, providing the response to the user may further include communicating the response to an external application, such as a supervisor application, a coaching application, or an agent application, wherein the response may include the summary, the insight, the recommendation, or a combination thereof.

In one or more embodiments, the monitored conversation analyzed in the method S100 may be a phone call or a chat conversation. If the conversation is a phone call, providing the response to the user may include providing the recommendation to the agent in a written text during the monitored conversation. If the monitored conversation is a chat, providing the response to the user may include providing the recommendation to the customer in a written text (or computer-generated speech of the written text for accessibility purposes) during the monitored conversation.

FIG. 12 is a flow chart for another method S200 for providing a context-based recommendation during a monitored conversation, in accordance with various embodiments. The method S200 may include additional processing steps subsequent to processing of method S100. For example, method S200 may include additional conversation analysis operations when a new word is spoken and transcribed. In such scenario, method S200 includes, at step S210, receiving a new set of transcribed words after a new word is transcribed during the monitored conversation; at step S220, analyzing the new set of transcribed words to produce an updated score; at step S230, generating, based on the updated score, an updated alert comprising a different model ID with a different model description; at step S240, creating a new set of prompts based on the updated alert with each new prompt comprising a new executable instruction that prompts the LLM for a new response; and at step S250, generating the new response different from the response.

In accordance with various embodiments, a non-transitory computer-readable medium may have stored thereon computer-readable instructions executable to provide a context-based recommendation during a monitored conversation using an artificial intelligence (AI)-based call response system, such as the systems described herein. The computer-readable instructions executable to perform conversation analysis operations may include determining transcribed words for the monitored conversation; analyzing the transcribed words using one or more machine learning models to produce a score associated with a model identifier (ID) identifying a machine learning model of the one or more machine learning models; comparing the score to a predefined threshold of the machine learning model; generating an alert when the score meets or exceeds the predefined threshold, the alert comprising the model ID and a call identifier (ID) identifying the monitored conversation; creating, based on the alert, one or more prompts with each prompt comprising an executable instruction that prompts, queries, or requests an output from a large language model (LLM) for a response; retrieving the response for each of the one or more prompts; and providing the response to a user. In one or more embodiments, the computer-readable instructions executable to perform conversation analysis operations may include registering the transcribed words with the call ID; and storing the transcribed words registered with the call ID in a storage. In one or more embodiments, creating the one or more prompts may include retrieving, from the storage, a model description of the model ID associated with the alert, the stored transcribed words corresponding to the call ID associated with the alert, or a combination thereof; and generating the executable instruction based on the model description, the transcribed words, or the combination thereof.

In one or more embodiments of the disclosed computer-readable instructions executable to perform conversation analysis operations, the response may include a summary of an interaction between a customer and an agent during the monitored conversation, an insight of the monitored conversation that includes an in-context explanation of the interaction capturing a behavior of the agent, or a recommendation that includes one or more in-context responses that follow definitions based on an experience of the customer during the monitored conversation.

What is claimed is:

1. An artificial intelligence (AI)-based call response system for providing a context-based recommendation during a monitored conversation, comprising:
one or more processors and a non-transitory computer readable medium operably coupled thereto, the non-transitory computer readable medium comprising a plurality of instructions stored in association therewith that are accessible to, and executable by, the one or more processors, to perform conversation analysis operations, which comprise:
determining transcribed words for the monitored conversation;
analyzing the transcribed words using one or more machine learning models to produce a score associated with a model identifier (ID) identifying a machine learning model of the one or more machine learning models;
comparing the score to a predefined threshold of the machine learning model;
generating an alert when the score meets or exceeds the predefined threshold, the alert comprising the model ID and a call identifier (ID) identifying the monitored conversation;
creating, based on the alert, one or more prompts with each prompt comprising an executable instruction that prompts, queries, or requests an output from a large language model (LLM) for a response;
retrieving the response for each of the one or more prompts; and
providing the response to a user.

2. The AI-based call response system of claim 1, wherein the conversation analysis operations further comprise:
registering the transcribed words with the call ID; and
storing the transcribed words registered with the call ID in a storage.

3. The AI-based call response system of claim 2, wherein the creating the one or more prompts comprises:
retrieving, from the storage, a model description of the model ID associated with the alert, the stored transcribed words corresponding to the call ID associated with the alert, or a combination thereof; and
generating the executable instruction based on the model description, the transcribed words, or the combination thereof.

4. The AI-based call response system of claim 1, wherein the response comprises:
a summary of an interaction between a customer and an agent during the monitored conversation,
an insight of the monitored conversation that includes an in-context explanation of the interaction capturing a behavior of the agent, or
a recommendation that includes one or more in-context responses that follow definitions based on an experience of the customer during the monitored conversation.

5. The AI-based call response system of claim 4, wherein the providing the response to the user comprises:
communicating the response to an external application, wherein the response comprises the summary, the insight, the recommendation, or a combination thereof.

6. The AI-based call response system of claim 4, wherein the monitored conversation is a phone call, and wherein the providing the response to the user comprises:
providing the recommendation to the agent in a written text during the monitored conversation.

7. The AI-based call response system of claim 4, wherein the monitored conversation is a chat, and wherein the providing the response to the user comprises:
providing the recommendation to the customer in a written text during the monitored conversation.

8. The AI-based call response system of claim 1, wherein the conversation analysis operations further comprise:
receiving a new set of transcribed words after a new word is transcribed during the monitored conversation;
analyzing the new set of transcribed words to produce an updated score;
generating, based on the updated score, an updated alert comprising a different model ID with a different model description;
creating a new set of prompts based on the updated alert with each new prompt comprising a new executable instruction that prompts the LLM for a new response; and
generating the new response different from the response.

9. A method for providing a context-based recommendation during a monitored conversation, the method comprising:
determining, via an automatic speech recognition system, transcribed words for the monitored conversation;
analyzing the transcribed words using one or more machine learning models to produce a score associated with a model identifier (ID) identifying a machine learning model of the one or more machine learning models;
comparing the score to a predefined threshold of the machine learning model;
generating an alert when the score meets or exceeds the predefined threshold, the alert comprising the model ID and a call identifier (ID) identifying the monitored conversation;
creating, based on the alert, one or more prompts with each prompt comprising an executable instruction that prompts, queries, or requests an output from a large language model (LLM) for a response;
retrieving the response for each of the one or more prompts; and
providing the response to a user.

10. The method of claim 9, further comprising:
registering the transcribed words with the call ID; and
storing the transcribed words registered with the call ID in a storage.

11. The method of claim 10, wherein the creating the one or more prompts comprises:
retrieving, from the storage, a model description of the model ID associated with the alert, the stored transcribed words corresponding to the call ID associated with the alert, or a combination thereof; and
generating the executable instruction based on the model description, the transcribed words, or the combination thereof.

12. The method of claim 9, wherein the response comprises:
a summary of an interaction between a customer and an agent during the monitored conversation,
an insight of the monitored conversation that includes an in-context explanation of the interaction capturing a behavior of the agent, or
a recommendation that includes one or more in-context responses that follow definitions based on an experience of the customer during the monitored conversation.

13. The method of claim 12, wherein the providing the response to the user comprises:
communicating the response to an external application, wherein the response comprises the summary, the insight, the recommendation, or a combination thereof.

14. The method of claim 12, wherein the monitored conversation is a phone call, and wherein the providing the response to the user comprises:
providing the recommendation to the agent in a written text during the monitored conversation.

15. The method of claim 12, wherein the monitored conversation is a chat, and wherein the providing the response to the user comprises:
providing the recommendation to the customer in a written text during the monitored conversation.

16. The method of claim 9, further comprising:
receiving a new set of transcribed words after a new word is transcribed during the monitored conversation;
analyzing the new set of transcribed words to produce an updated score;
generating, based on the updated score, an updated alert comprising a different model ID with a different model description;
creating a new set of prompts based on the updated alert with each new prompt comprising a new executable instruction that prompts the LLM for a new response; and
generating the new response different from the response.

17. A non-transitory computer-readable medium having stored thereon computer-readable instructions executable to provide a context-based recommendation during a monitored conversation using an artificial intelligence (AI)-based call response system, the computer-readable instructions executable to perform conversation analysis operations, which comprise:
determining transcribed words for the monitored conversation;
analyzing the transcribed words using one or more machine learning models to produce a score associated with a model identifier (ID) identifying a machine learning model of the one or more machine learning models;
comparing the score to a predefined threshold of the machine learning model;
generating an alert when the score meets or exceeds the predefined threshold, the alert comprising the model ID and a call identifier (ID) identifying the monitored conversation;
creating, based on the alert, one or more prompts with each prompt comprising an executable instruction that prompts, queries, or requests an output from a large language model (LLM) for a response;
retrieving the response for each of the one or more prompts; and
providing the response to a user.

18. The non-transitory computer-readable medium of claim 17, wherein the conversation analysis operations further comprise:
registering the transcribed words with the call ID; and
storing the transcribed words registered with the call ID in a storage.

19. The non-transitory computer-readable medium of claim 18, wherein the creating the one or more prompts comprises:
retrieving, from the storage, a model description of the model ID associated with the alert, the stored transcribed words corresponding to the call ID associated with the alert, or a combination thereof; and
generating the executable instruction based on the model description, the transcribed words, or the combination thereof.

20. The non-transitory computer-readable medium of claim 17, wherein the response comprises:
a summary of an interaction between a customer and an agent during the monitored conversation,
an insight of the monitored conversation that includes an in-context explanation of the interaction capturing a behavior of the agent, or
a recommendation that includes one or more in-context responses that follow definitions based on an experience of the customer during the monitored conversation.
